(19) United States
(12) Patent Application Publication
(10) Pub. No.: US 2026/0134267 A1
(43) Pub. Date: May 14, 2026

(54) THREE-DIMENSIONAL GRAVITY GRADIENT TENSOR INVERSION METHOD WITH PHYSICAL INFORMATION CONSTRAINTS

(71) Applicant: Central South University, Changsha (CN)

(72) Inventors: Zhuo LIU, Changsha (CN); Zhenwei GUO, Changsha (CN); Boyao ZHANG, Changsha (CN); Jianxin LIU, Changsha (CN); Xiaolong WEI, Changsha (CN); Bochen WANG, Changsha (CN); Xintao LI, Changsha (CN)

(73) Assignee: Central South University, Changsha, HN (CN)

(21) Appl. No.: 19/442,503

(22) Filed: Jan. 7, 2026

(30) Foreign Application Priority Data
Jan. 22, 2025 (CN) 202510101709.9

(51) Int. Cl. G06N 3/048

(52) U.S. Cl. CPC G06N 3/048

(57) ABSTRACT

The invention provides a three-dimensional gravity gradient tensor inversion method with physical information constraints. Firstly, the coordinate system is established according to the gravity gradient tensor data and the underground space is divided, and the coordinates of the center point of the cube are extracted and normalized; then, a seven-layer fully connected neural network is constructed to output the network output parameters; an then the gravity gradient tensor data are calculated on the observation surface, the objective function is constructed by observation data and calculation data, including a data term and a regularization item; and finally, the objective function is automatically differentiated to update the network parameters and optimize the network output parameters until the maximum training times are reached. The invention overcomes challenges in existing methods, including over-reliance on initial parameters, over-simplification of the model and assumptions, insufficient ability to deal with nonlinear relationships, and poor generalization performance.

### TECHNICAL FIELD

The invention relates to geophysics, specifically, a three-dimensional gravity gradient tensor inversion method with physical information constraints.

### BACKGROUND

The gravity field is one of the basic physical fields of the earth, which reflects the distribution of the earth's material and its changes in space and time. As the change rate of the gravity field in space, the gravity gradient field has a higher resolution than the gravity field, therefore, it has been widely used in many important fields such as natural resource exploration, topographic mapping, hydrocarbon exploration, microgravity research, and underground military target detection. In recent years, airborne gravity gradient measurement technology has made remarkable progress, especially in measuring complex terrain areas such as mountains, offshore waters, lakes, swamps, and so on. The full-tensor gravity gradient data is composed of five independent components, which are more sensitive to spatial anomalies and can accurately describe the structural characteristics and location of underground anomalies.

Airborne gravity gradient tensor data inversion mainly includes physical property inversion and geometric parameter inversion. Geometric parameter inversion can quickly locate the spatial distribution characteristics and location of anomalous bodies through imaging methods, while physical property inversion can provide more detailed information about anomalous bodies, such as shape, volume, and physical property parameters. However, the traditional inversion method has some limitations, such as easy falling into local minimum, over-reliance on initial parameters, model simplification, and hypothesis limitation, and limited ability to deal with nonlinear relationships.

With the rapid development of artificial intelligence technology, deep learning provides new ideas and methods for the field of geophysics. Geophysicists have applied deep learning technology to the joint inversion of gravity gradient tensor data. The data-driven convolutional neural network (CNN) is used to establish the mapping relationship between input and output, which effectively improves the inversion accuracy and reduces the dependence on prior knowledge and model setting in traditional inversion methods.

However, data-driven deep learning methods also have shortcomings, such as the need for a large amount of training data, reduced generalization, and poor interpretability. In order to solve these problems, researchers have proposed a strategy for embedding physical information constraints in deep learning networks. By incorporating the forward modeling process based on physical laws into the training process of the neural network, the network can not only learn the characteristics of the data, but also ensure that the inversion results conform to the physical laws, thereby enhancing the interpretability and generalization ability of the model. This strategy provides a solution to the key challenges of solving the generalization and data dependence of inversion problems.

### SUMMARY

The purpose of this invention is to provide a three-dimensional gravity gradient tensor inversion method with physical information constraints, which can significantly overcome multiple challenges in existing technologies, including over-reliance on initial parameters, over-simplification of models and assumptions, insufficient ability to deal with nonlinear relationships, and poor generalization performance; by integrating physical information constraints into the deep learning network, this method realizes the three-dimensional gravity gradient tensor inversion under the dual guidance of data-driven and physical laws, and provides an innovative intelligent solution for the three-dimensional inversion task in the field of gravity gradient exploration.

In order to achieve the above purpose, the invention provides a three-dimensional gravity gradient tensor inversion method with physical information constraints, including the following steps:
S1, according to the measured data of the gravity gradient tensor, establishing the ground rectangular coordinate system, dividing the underground space into small cubes with constant intervals along the x, y, and z directions, the intervals of the underground space are Δx, Δy and Δz respectively, the number of grids in the three directions of x, y and z are M, N and L respectively, and the total number of cubes is Nₛ=M×N×L, extracting the coordinates of the center points of Nₛ cubes for standard normalization to form the normalized coordinate dᵢₙₚᵤₜ;
S2, constructing a seven-layer fully connected neural network framework, the activation function is ReLU, the optimizer is Adam optimizer, the input is the standard normalized coordinate dᵢₙₚᵤₜ, and obtaining the network output parameter ρ;
S3, setting an observation surface N₀ at z=z₀, dividing the observation surface into N₀=M×N, and obtaining the observation point coordinate (xₘ, yₙ, z₀), calculating the kernel matrix according to the spatial position of each cube and observation point, bringing the network output parameter ρ and the kernel matrix into the gravity gradient tensor calculation formula to obtain the gravity gradient tensor data;
S4, constructing the data items in the objective function by the gravity gradient tensor observation data and the gravity gradient tensor data obtained in S3, using the kernel matrix and the network output parameter ρ to construct the regularization item in the objective function, and combining the data item and the regularization item to obtain the objective function;
S5, according to the objective function constructed in S4, performing an automatic differentiation to update the network parameters, and then optimizing the network output parameter ρ to fit the measured data, when the number of training times reaches the maximum, outputting the results.

Preferably, the standard normalization formula in S1 is as follows:

$$\begin{matrix}ξ * & = \frac{ξ - μ}{δ} \\ η * & = \frac{η - μ}{δ} \\ ζ * & = \frac{ζ - μ}{δ}\end{matrix} ;$$

where ξ, η and ζ are the coordinate values of the center point of the cube in three directions, μ is the average value of all coordinates, and δ is the standard deviation of all coordinates;
the calculation formulas of μ and δ are as follows:

$$μ = \frac{1}{3 {N}_{S}} {\sum }_{p = 1}^{{N}_{S}} ( {ξ}_{p} + {η}_{p} + {ζ}_{p} )$$

$$δ = \sqrt{\frac{1}{3 {N}_{S}} {\sum }_{p = 1}^{{N}_{S}} ( {( {ξ}_{p} - μ )}^{2} + {( {η}_{p} - μ )}^{2} + {( {ζ}_{p} - μ )}^{2} )} ;$$

where ξₚ, ηₚ and ζₚ are the coordinate values of the center point of the p-th cube in three directions;
the normalized coordinate dᵢₙₚᵤₜ is as follows:

$${d}_{input} = [ {ξ}^{*} , {η}^{*} , {ζ}^{*} ] ;$$

where ξ*, η* and ζ* are the coordinate values of the center point of the cube in three directions after standard normalization.

Preferably, the kernel matrix formula in S3 is as follows:

$${k}_{xx} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{y}_{j} {z}_{k}}{{x}_{i} {R}_{ijk}} ;$$

$${k}_{yy} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {z}_{k}}{{y}_{j} {R}_{ijk}} ;$$

$${k}_{zz} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {y}_{j}}{{z}_{k} {R}_{ijk}} ;$$

$${k}_{xy} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {z}_{k} + {R}_{ijk} ) ;$$

$${k}_{xz} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {y}_{j} + {R}_{ijk} ) ;$$

$${k}_{yz} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {x}_{i} + {R}_{ijk} ) ;$$

where kₓₓ, k_{yy}, k_{zz}, k_{xy}, k_{xz}, k_{yz} are the kernel matrices in six different directions; xᵢ, yⱼ, zₖ are the distances between the two corners of the cube and the observation point in three directions;
the calculation formulas of xᵢ, yⱼ, zₖ are as follows:

$${x}_{1} = {ξ}_{p} - 0.5 Δ x - {x}_{m} , {x}_{2} = {ξ}_{p} + 0.5 Δ x - {x}_{m}$$

$${y}_{1} = {η}_{p} - 0.5 Δ y - {y}_{n} , {y}_{2} = {η}_{p} + 0.5 Δ y - {y}_{n}$$

$${z}_{1} = {ζ}_{p} - 0.5 Δ z - {z}_{0} , {z}_{2} = {ζ}_{p} + 0.5 Δ z - {z}_{0} ;$$

the calculation formula of uᵢⱼₖ and Rᵢⱼₖ is as follows:

$${R}_{ijk} = \sqrt{{x}_{i}^{2} + {y}_{j}^{2} + {z}_{k}^{2}} , {u}_{ijk} = {( - 1 )}^{i + j + k}$$

Preferably, the formula for calculating the gravity gradient tensor in S3 is as follows:

$${g}_{xx} = {k}_{xx} ρ ;$$

$${g}_{yy} = {k}_{yy} ρ ;$$

$${g}_{zz} = {k}_{zz} ρ ;$$

$${g}_{xy} = {k}_{xy} ρ ;$$

$${g}_{xz} = {k}_{xz} ρ ;$$

$${g}_{yz} = {k}_{yz} ρ ;$$

where gₓₓ, g_{yy}, g_{zz}, g_{xy}, g_{xz}, g_{yz} are gravity gradient tensor data in six different directions, and ρ is the output parameter of the network.

Preferably, the formula for constructing data items in S4 is as follows:

$${Loss}_{d} ( ρ ) = {‖ {g}_{xx} - {g}_{xx} ‖}^{2} + {‖ {g}_{yy} - {g}_{yy} ‖}^{2} + {‖ {g}_{zz} - {g}_{zz} ‖}^{2} + {‖ {g}_{xy} - {g}_{xy} ‖}^{2} + {‖ {g}_{xz} - {g}_{xz} ‖}^{2} + {‖ {g}_{y z} - {g}_{y z} ‖}^{2} ;$$

where gₓₓ, g_{yy}, g_{zz}, g_{xy}, g_{xz}, g_{yz} are measured data of gravity gradient tensor in six different directions.

Preferably, the regularization item formula constructed in S4 is as follows:

$${Loss}_{m} ( ρ ) = χ \vert W ρ \vert + ( 1 - χ ) {‖ W ρ ‖}^{2} ;$$

where W is the depth weighting function based on the kernel matrix, and X is the balance parameter to balance the two regularization items;
the depth weighting function formula is as follows:

$$W = [ \frac{1}{6} {( {( {k}_{xx}^{T} {k}_{xx} )}^{2} + {( {k}_{yy}^{T} {k}_{yy} )}^{2} + {( {k}_{zz}^{T} {k}_{zz} )}^{2} + {( {k}_{x γ}^{T} {k}_{x γ} )}^{2} + {( {k}_{xz}^{T} {k}_{xz} )}^{2} + {( {k}_{y z}^{T} {k}_{y z} )}^{2} )}^{\frac{1}{2}} ]$$

Preferably, the objective function formula in S4 is as follows:

$$Loss ( ρ ) = {Loss}_{d} ( ρ ) + {λLoss}_{m} ( ρ )$$

where λ is the regularization coefficient of the balanced data term and the regularization item.

Therefore, the invention adopts the above-mentioned three-dimensional gravity gradient tensor inversion method with physical information constraints, the technical effects are as follows: The method proposed in this invention uses the physical information-constrained neural network to perform three-dimensional gravity gradient tensor inversion, which effectively avoids the shortcomings of the existing methods, such as over-reliance on initial parameters, model simplification, and hypothesis limitations, limited ability to deal with nonlinear relationships, and poor generalization, the traditional forward modeling of three-dimensional gravity gradient tensor is combined with neural network technology to achieve high-efficiency and high-precision three-dimensional gravity gradient tensor inversion.

### BRIEF DESCRIPTION OF THE DRAWINGS

FIG. 1 is a three-dimensional synthetic model of the three-dimensional gravity gradient tensor inversion method with physical information constraints.

FIG. 2 is a schematic diagram of the underground space structure of the three-dimensional gravity gradient tensor inversion method with physical information constraints.

FIG. 3 is a seven-layer fully connected neural network framework flow chart of the three-dimensional gravity gradient tensor inversion method with physical information constraints.

FIG. 4 is the three-dimensional inversion result of the three-dimensional gravity gradient tensor inversion method with physical information constraints.

FIG. 5 shows the synthetic data, the forward response of the inversion model, and the absolute error of the three-dimensional gravity gradient tensor inversion method with physical information constraints.

### DETAILED DESCRIPTION OF THE EMBODIMENTS

The following is a further explanation of the technical scheme of the invention through drawings and embodiments.

Unless otherwise defined, the technical terms or scientific terms used in the invention should be understood by people with general skills in the field to which the invention belongs.

### Embodiment 1

The invention provides a three-dimensional gravity gradient tensor inversion method with physical information constraints, the specific steps are as follows:

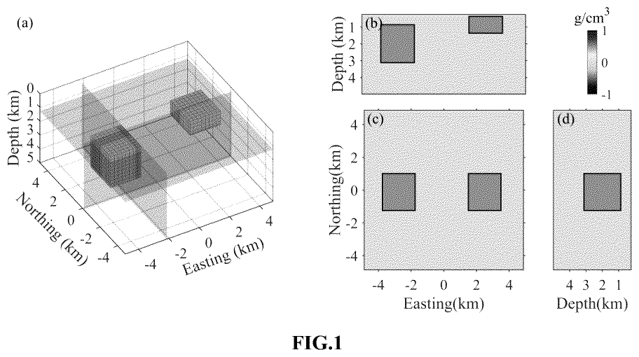

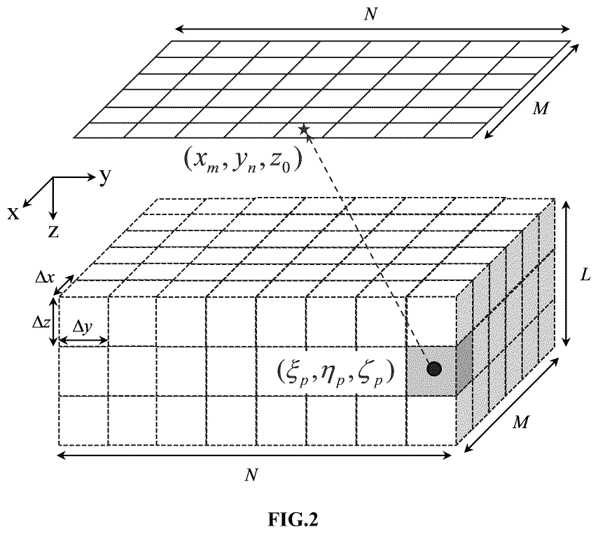

S1, according to the measured data of the gravity gradient tensor, the ground rectangular coordinate system is established, as shown in FIG. 1-FIG. 2. In FIG. 1, (a) is the three-dimensional synthetic real model of the invention, (b) is the slice diagram when y=0, (c) is the slice diagram when z=1.25, and (d) is the slice diagram when x=2. The underground space is divided into small cubes with constant intervals along the x, y, and z directions, the interval sizes of the underground space are 0.25 km, 0.25 km, and 0.25 km, respectively, and the number of grids divided in the x, y, and z directions is 40,40, and 20, respectively, the total number of cubes is Nₛ=40×40×20, and the coordinates of 32000 cube center points are extracted for standard normalization to form the normalized coordinates dᵢₙₚᵤₜ.

The standard normalization formula is as follows:

$${ξ}^{*} = \frac{ξ - μ}{δ}$$

$${η}^{*} = \frac{η - μ}{δ}$$

$${ζ}^{*} = \frac{ζ - μ}{δ}$$

where ξ, η and ζ are the coordinate values of the center point of the cube in three directions, μ is the average value of all coordinates, and δ is the standard deviation of all coordinates;
the calculation formulas of μ and δ are as follows:

$$μ = \frac{1}{3 {N}_{S}} {\sum }_{p = 1}^{{N}_{S}} ( {ξ}_{p} + {η}_{p} + {ζ}_{p} )$$

$$δ = \sqrt{\frac{1}{3 {N}_{S}} {\sum }_{p = 1}^{{N}_{S}} ( {( {ξ}_{p} - μ )}^{2} + {( {η}_{p} - μ )}^{2} + {( {ζ}_{p} - μ )}^{2} )} ;$$

where ξₚ, ηₚ and ζₚ are the coordinate values of the center point of the p-th cube in three directions;
the normalized coordinate dᵢₙₚᵤₜ is as follows:

$${d}_{input} = [ {ξ}^{*} , {η}^{*} , {ζ}^{*} ] ;$$

where ξ*, η* and ζ* are the coordinate values of the center point of the cube in three directions after standard normalization.

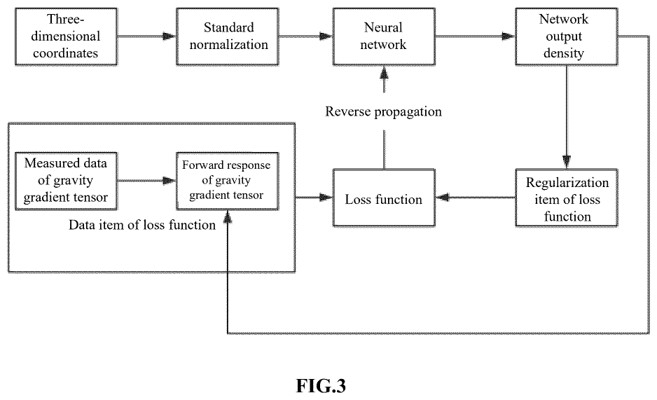

S2, as shown in FIG. 3, a seven-layer fully connected neural network framework is constructed, the activation function is ReLU, the optimizer is Adam optimizer, and the input is the standard normalized coordinate dᵢₙₚᵤₜ, and the network output parameter ρ is obtained.

S3, the observation surface N₀ is set at z=z₀, and the numbers of grids in the x and y directions are 40 and 40, respectively, the observation surface is divided into N₀=40×40, and the coordinate of the observation point (xₘ, yₙ, z₀) is obtained, the kernel matrix is calculated according to the spatial position of each cube and the observation point, the network output parameter ρ and the kernel matrix are brought into the gravity gradient tensor calculation formula to obtain the gravity gradient tensor data.

The kernel matrix formula is as follows:

$${k}_{xx} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{y}_{j} {z}_{k}}{{x}_{i} {R}_{ijk}} ;$$

$${k}_{yy} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {z}_{k}}{{y}_{j} {R}_{ijk}} ;$$

$${k}_{zz} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {y}_{j}}{{z}_{k} {R}_{ijk}} ;$$

$${k}_{xy} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {z}_{k} + {R}_{ijk} ) ;$$

$${k}_{xz} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {y}_{j} + {R}_{ijk} ) ;$$

$${k}_{yz} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {x}_{i} + {R}_{ijk} ) ;$$

where kₓₓ, k_{yy}, k_{zz}, k_{xy}, k_{xz}, k_{yz} are the kernel matrices in six different directions; xᵢ, yⱼ, zₖ are the distances between the two corners of the cube and the observation point in three directions;
the calculation formula of x, y, z, is as follows:

$${x}_{1} = {ξ}_{p} - 0.5 Δ x - {x}_{m} , {x}_{2} = {ξ}_{p} + 0.5 Δ x - {x}_{m}$$

$${y}_{1} = {η}_{p} - 0.5 Δ y - {y}_{n} , {y}_{2} = {η}_{p} + 0.5 Δ y - {y}_{n}$$

$${z}_{1} = {ζ}_{p} - 0.5 Δ z - {z}_{0} , {z}_{2} = {ζ}_{p} + 0.5 Δ z - {z}_{0} ;$$

the calculation formula of uᵢⱼₖ, Rᵢⱼₖ is as follows:

$${R}_{ijk} = \sqrt{{x}_{i}^{2} + {y}_{j}^{2} + {z}_{k}^{2}} , {u}_{ijk} = {( - 1 )}^{i + j + k}$$

the calculation formula of the gravity gradient tensor is as follows:

$${g}_{xx} = {k}_{xx} ρ ;$$

$${g}_{yy} = {k}_{yy} ρ ;$$

$${g}_{zz} = {k}_{zz} ρ ;$$

$${g}_{xy} = {k}_{xy} ρ ;$$

$${g}_{xz} = {k}_{xz} ρ ;$$

$${g}_{yz} = {k}_{yz} ρ ;$$

where gₓₓ, g_{yy}, g_{zz}, g_{xy}, g_{xz}, g_{yz} are gravity gradient tensor data in six different directions, and ρ is the output parameter of the network.

S4, the data items in the objective function are constructed by the gravity gradient tensor observation data and the gravity gradient tensor data obtained in S3, the kernel matrix and the network output parameter ρ are used to construct the regularization item in the objective function, and the data item and the regularization item are combined to obtain the objective function;
the formula for constructing data items in S4 is as follows:

$${Loss}_{d} ( ρ ) = {‖ {g}_{xx} - {g}_{xx} ‖}^{2} + {‖ {g}_{yy} - {g}_{yy} ‖}^{2} + {‖ {g}_{zz} - {g}_{zz} ‖}^{2} + {‖ {g}_{xy} - {g}_{xy} ‖}^{2} + {‖ {g}_{xz} - {g}_{xz} ‖}^{2} + {‖ {g}_{y z} - {g}_{y z} ‖}^{2} ;$$

where gₓₓ, g_{yy}, g_{zz}, g_{xy}, g_{xz}, g_{yz} are measured data of gravity gradient tensor in six different directions.

The regularization item formula constructed is as follows:

$${Loss}_{m} ( ρ ) = χ \vert W ρ \vert + ( 1 - χ ) {‖ W ρ ‖}^{2} ;$$

where W is the depth weighting function based on the kernel matrix, and X is the balance parameter to balance the two regularization items, the value of X is 0.9;
the depth weighting function formula is as follows:

$$W = [ \frac{1}{6} {( {( {k}_{xx}^{T} {k}_{xx} )}^{2} + {( {k}_{yy}^{T} {k}_{yy} )}^{2} + {( {k}_{zz}^{T} {k}_{zz} )}^{2} + {( {k}_{xy}^{T} {k}_{xy} )}^{2} + {( {k}_{xz}^{T} {k}_{xz} )}^{2} + {( {k}_{y z}^{T} {k}_{y z} )}^{2} )}^{\frac{1}{2}} ]$$

$$Loss ( ρ ) = {Loss}_{d} ( ρ ) + λ Los {s}_{m} ( ρ )$$

The objective function formula is as follows:

where λ is the regularization coefficient of the balanced data term and the regularization item, and the value of λ is 0.25.

S5, according to the objective function constructed in S4, automatic differentiation is performed to update the network parameters, and then the network output parameter ρ is optimized to fit the measured data, when the number of training times reaches the maximum, the results are output.

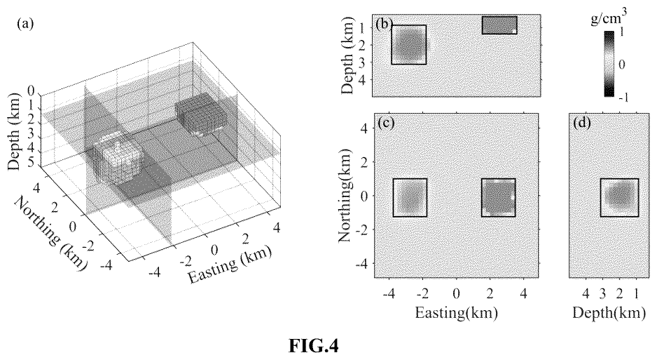

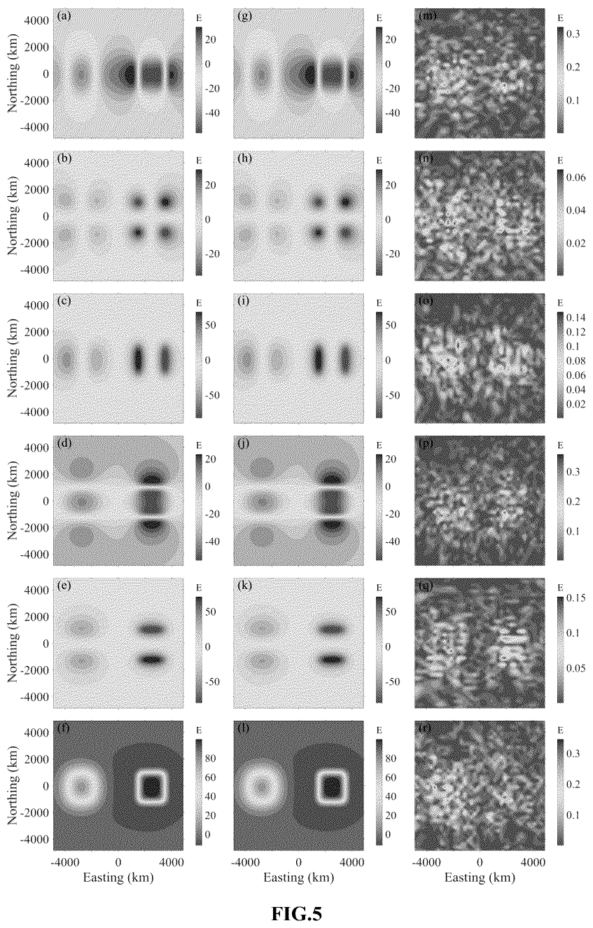

As shown in FIG. 4-FIG. 5, FIG. 4 is the three-dimensional inversion result of the embodiment, and FIG. 4 (a) is a three-dimensional visualization inversion model; (b) is the slice diagram when y=0; (c) is the slice diagram when z=1.25; (d) is the slice diagram when x=2. Where the black frame line is the boundary of the real model. FIG. 5 is the synthetic data of the embodiment, the forward responses of the inversion model, and the absolute errors of the two indicators. (a)-(f) in FIG. 5 are the synthetic data; (g)-(l) are the forward responses of the inversion model in FIG. 4; (m)-(r) are the absolute errors of the two indicators.

The synthetic data of the six sets of data in FIG. 5, the forward responses of the inversion model, and the absolute errors of the two indicators are compared horizontally, (a)-(f) denote the theoretical gravity gradient tensor data, which is the goal of inversion, (g)-(l) denote the gravity gradient tensor data obtained by the inversion results obtained by the method of the invention and then calculated by the forward calculation. By comparing the two sets of data, it can be seen that the inversion results are very close to the synthetic data, indicating that the method of the invention can accurately restore the density distribution of physical parameters underground. (m)-(r) denote the difference between the synthetic data and the forward response of the inversion model, it can be seen from the absolute error diagram that the error values are relatively small and evenly distributed, which further proves the high precision and stability of the proposed method. It can be concluded that the three-dimensional gravity gradient tensor inversion method with physical information constraints proposed by the invention can achieve high-precision inversion of physical parameter density, and has significant technical advantages and practical effects.

Therefore, the invention uses the above-mentioned three-dimensional gravity gradient tensor inversion method with physical information constraints, by integrating the gravity gradient tensor forward operator, the traditional forward modeling of the three-dimensional gravity gradient tensor is combined with the neural network technology, which significantly reduces the inversion multiplicity, compared with the existing deep learning technology, this method effectively enhances the generalization of inversion and reduces the dependence on data.

Finally, it should be explained that the above embodiment is only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A three-dimensional gravity gradient tensor inversion method with physical information constraints, comprising the following steps:
S1, according to measured data of the gravity gradient tensor, establishing a ground rectangular coordinate system, dividing a underground space into small cubes with constant intervals along the x, y, and z directions, wherein the intervals of the underground space are Δx, Δy and Δz respectively, a number of grids in three directions of x, y, and z are M, N, and L respectively, and a total number of cubes is Nₛ=M×N×L, and extracting coordinates of the center points of Nₛ cubes for standard normalization to form a normalized coordinate dᵢₙₚᵤₜ;
S2, constructing a seven-layer fully connected neural network framework, wherein an activation function is ReLU, an optimizer is Adam optimizer, an input is the standard normalized coordinate dᵢₙₚᵤₜ, and obtaining a network output parameter ρ;
S3, setting an observation surface N₀ at z=z₀, dividing an observation surface into N₀=M×N, and obtaining an observation point coordinate (xₘ, yₙ,z₀), calculating a kernel matrix according to a spatial position of each cube and observation point, bringing a network output parameter ρ and a kernel matrix into a gravity gradient tensor calculation formula to obtain a gravity gradient tensor data;
S4, constructing data items in an objective function by gravity gradient tensor observation data and the gravity gradient tensor data obtained in S3, using the kernel matrix and the network output parameter ρ to construct a regularization item in the objective function, and combining a data item and the regularization item to obtain the objective function;
S5, according to the objective function constructed in S4, performing an automatic differentiation to update the network parameters, and then optimizing the network output parameter ρ to fit the measured data, and, when a number of training times reaches a maximum, outputting results.

2. The three-dimensional gravity gradient tensor inversion method with physical information constraints according to claim 1, wherein a standard normalization formula in S1 is as follows:
$${ξ}^{*} = \frac{ξ - μ}{δ}$$
$${η}^{⋆} = \frac{η - μ}{δ}$$
$${ζ}^{*} = \frac{ζ - μ}{δ} ;$$
where ξ, η and ζ are coordinate values of the center point of the cube in three directions, μ is an average value of all coordinates, and δ is a standard deviation of all coordinates;
the calculation formulas of μ and δ are as follows:
$$μ = \frac{1}{3 {N}_{S}} {\sum }_{p = 1}^{{N}_{S}} ( {ξ}_{p} + {η}_{p} + {ζ}_{p} )$$
$$δ = \sqrt{\frac{1}{3 {N}_{S}} {\sum }_{p = 1}^{{N}_{S}} ( {( {ξ}_{p} - μ )}^{2} + {( {η}_{p} - μ )}^{2} + {( {ζ}_{p} - μ )}^{2} )} ;$$
where ξₚ, ηₚ and ζₚ are coordinate values of a center point of a p-th cube in three directions;
a normalized coordinate dᵢₙₚᵤₜ is as follows:
$${d}_{input} = [ {ξ}^{*} , {η}^{*} , {ζ}^{*} ] ;$$
where ξ*, η* and ζ* are coordinate values of a center point of cube in three directions after standard normalization.

3. The three-dimensional gravity gradient tensor inversion method with physical information constraints according to claim 1, wherein a kernel matrix formula in S3 is as follows:
$${k}_{xx} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{y}_{j} {z}_{k}}{{x}_{i} {R}_{ijk}} ;$$
$${k}_{yy} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {z}_{k}}{{y}_{j} {R}_{ijk}} ;$$
$${k}_{zz} ( {x}_{m} , {y}_{n} , {z}_{0} ) = G {\sum }_{i = 1}^{2} {\sum }_{j = 1}^{2} {\sum }_{k = 1}^{2} {u}_{ijk} \times arctan \frac{{x}_{i} {y}_{j}}{{z}_{k} {R}_{ijk}} ;$$
$${k}_{xy} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {z}_{k} + {R}_{ijk} ) ;$$
$${k}_{xz} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {y}_{j} + {R}_{ijk} ) ;$$
$${k}_{y z} ( {x}_{m} , {y}_{n} , {z}_{0} ) = - G {\sum }_{i = 1}^{2} {\sum }_{j = 1}^{2} {\sum }_{k = 1}^{2} {u}_{ijk} \times ln ( {x}_{i} + {R}_{ijk} ) ;$$
where kₓₓ, k_{yy}, k_{zz}, k_{xy}, k_{xz}k_{yz} are kernel matrices in six different directions; xᵢ, yⱼ, zₖ are distances between two corners of a cube and an observation point in three directions;
a calculation formulas of xᵢ, yⱼ, zₖ are as follows:
$${x}_{1} = {ξ}_{p} - 0.5 Δ x - {x}_{m} , {x}_{2} = {ξ}_{p} + 0.5 Δ x - {x}_{m}$$
$${y}_{1} = {η}_{p} - 0.5 Δ y - {y}_{n} , {y}_{2} = {η}_{p} + 0.5 Δ y - {y}_{n}$$
$${z}_{1} = {ζ}_{p} - 0.5 Δ z - {z}_{0} , {z}_{2} = {ζ}_{p} + 0.5 Δ z - {z}_{0} ;$$
a calculation formula of uᵢⱼₖ and Rᵢⱼₖ is as follows:
$${R}_{ikj} = \sqrt{{x}_{i}^{2} + {y}_{j}^{2} + {z}_{k}^{2}} , {u}_{ijk} = {( - 1 )}^{i + j + k} .$$

4. The three-dimensional gravity gradient tensor inversion method with physical information constraints according to claim 1, wherein the formula for calculating the gravity gradient tensor in S3 is as follows:
$${g}_{xx} = {k}_{xx} ρ ;$$
$${g}_{yy} = {k}_{yy} ρ ;$$
$${g}_{zz} = {k}_{zz} ρ ;$$
$${g}_{xy} = {k}_{xy} ρ ;$$
$${g}_{xz} = {k}_{xz} ρ ;$$
$${g}_{yz} = {k}_{yz} ρ ;$$
where gₓₓ, g_{yy}, g_{zz}, g_{xy}, g_{xz}, g_{yz} are gravity gradient tensor data in six different directions, and ρ is the output parameter of the network.

5. The three-dimensional gravity gradient tensor inversion method with physical information constraints according to claim 1, wherein a formula for constructing data items in S4 is as follows:
$${Loss}_{d} ( ρ ) = {‖ {g}_{xx} - {g}_{xx} ‖}^{2} + \text{} {‖ {g}_{yy} - {g}_{yy} ‖}^{2} + {‖ {g}_{zz} - {g}_{zz} ‖}^{2} + {‖ {g}_{xy} - {g}_{xy} ‖}^{2} + {‖ {g}_{xz} - {g}_{xz} ‖}^{2} + {‖ {g}_{y z} - {g}_{y z} ‖}^{2} ;$$
where gₓₓ, g_{yy}, g_{zz}, g_{xy}, g_{xz}, g_{yz} are measured data of gravity gradient tensor in six different directions.

6. The three-dimensional gravity gradient tensor inversion method with physical information constraints according to claim 1, wherein the regularization item formula constructed in S4 is as follows:
$${Loss}_{m} ( ρ ) = χ \vert W ρ \vert + ( 1 - χ ) {‖ W ρ ‖}^{2} ;$$
where W is a depth weighting function based on a kernel matrix, and X is a balance parameter to balance two regularization items;
and a depth weighting function formula is as follows:
$$W = [ \frac{1}{6} {( {( {k}_{xx}^{T} {k}_{xx} )}^{2} + {( {k}_{yy}^{T} {k}_{yy} )}^{2} + {( {k}_{zz}^{T} {k}_{zz} )}^{2} + {( {k}_{xy}^{T} {k}_{xy} )}^{2} + {( {k}_{xz}^{T} {k}_{xz} )}^{2} + {( {k}_{y z}^{T} {k}_{y z} )}^{2} )}^{\frac{1}{2}} ] .$$

7. The three-dimensional gravity gradient tensor inversion method with physical information constraints according to claim 1, wherein an objective function formula in S4 is as follows:
$$Loss ( ρ ) = {Loss}_{d} ( ρ ) + λ Los {s}_{m} ( ρ )$$
where λ is the regularization coefficient of a balanced data term and a regularization item.
